(19) United States
(12) Patent Application Publication
(10) Pub. No.: US 2016/0070072 A1
(43) Pub. Date: Mar. 10, 2016

(54) VERSATILE SYSTEM FOR CONFIGURABLE HYBRID FIBER-OPTIC/ELECTRICAL CONNECTORS

(71) Applicants: Venkata R. Penumatcha, Plano, TX (US); Vincent A. Wouters, McKinney, TX (US); Rodney M. Flower, Richardson, TX (US)

(72) Inventors: Venkata R. Penumatcha, Plano, TX (US); Vincent A. Wouters, McKinney, TX (US); Rodney M. Flower, Richardson, TX (US)

(73) Assignee: Applied Optical Systems, Inc., Plano, TX (US)

(21) Appl. No.: 14/817,851

(22) Filed: Aug. 4, 2015

Related U.S. Application Data
(63) Continuation of application No. 13/285,954, filed on Oct. 31, 2011, now abandoned.
Application No. 13/285,954 is a continuation of application No. 12/905,883, filed on Oct. 15, 2010, now abandoned.
Application No. 12/905,883 is a continuation of application No. 11/282,296, filed on Nov. 18, 2005, now abandoned.

(51) Int. Cl. G02B 6/38

(52) U.S. Cl. CPC G02B 6/3817; G02B 6/3894; G02B 6/3878; G02B 6/3825

(57) ABSTRACT

A system for providing a configurable hybrid electrical/optical connector assembly is disclosed. The system provides a connector housing, having a channel through which some connection between transmission elements is made. An insert cap is produced, securable to the housing within the channel. The insert cap has a plurality of universal channel apertures formed through it. An electrical channel insert is provided, and disposed within one of the plurality of channel apertures. The electrical channel insert is adapted to secure an electrical transmission element. An optical channel insert is also provided, and disposed within another of the plurality of channel apertures. The optical channel insert is adapted to secure an optical transmission element.

### CROSS-REFERENCE TO RELATED APPLICATION(S)

This application is a continuation of prior U.S. patent application Ser. No. 13/285,954 filed Oct. 31, 2011, which is a continuation of prior U.S. patent application Ser. No. 12/905,883, filed on Oct. 15, 2010 (abandoned), which is a continuation of prior U.S. patent application Ser. No. 11/282,296 filed on Nov. 18, 2005 (abandoned).

### TECHNICAL FIELD OF THE INVENTION

The present application relates generally to the fields of couplings and connectors and, more particularly, to a versatile system for providing configurable connectors capable of concurrently supporting fiber-optic and electrical connections and terminals.

### BACKGROUND OF THE INVENTION

Electronic data processing and transmission systems are rapidly becoming ubiquitous, even as demands increase for continually improving performance and cost-efficiency from such systems. Data processing and transmission devices rely on some form of connection to power supply and data transmission systems. For example, personal computers are electrically powered by connections to standard household receptacles, and also are networked or interconnected by wide area and local area networks with other computers, servers and related data processing and transmission devices.

In the past, most power supply and data transmission needs were addressed using exclusively electrical signals and transmission media. Over time, however, electrical transmission technologies have—in many applications—given way to optical transmission technologies having superior performance characteristics. For example, extensive fiber optic networks have been developed for providing long-range signal transmission in a manner much more efficient and effective than a comparable electrical network.

As the prevalence of optical transmission technologies has increased, modern data processing and transmission systems have been modified and designed to utilize both electrical and optical technologies. Frequently, therefore, systems may rely upon electrical signal transmission, optical signal transmission, or some form of signal transmission (including power) that combines or converts both electrical and optical signal transmission. Commonly, certain signal transmission elements have taken to integrating electrical and optical media where possible, to reduce cost and improve efficiency. Consider, for example, the increasing introduction and use of cabling that integrates both optical and electrical transmission media within a single cable. Standard and user-configurable cabling having both optical and electrical channels is growing in availability and utilization. Correspondingly, the interconnection of systems must also address the presence or utilization of both electrical and optical transmission media.

As such, a need exists for robust connectors and receptacles that connect both electrical and optical signal conductors. Until recently, design constraints and cost concerns for most commercial and consumer applications have militated in favor of separate connectors for optical and electrical elements. Under conventional schemes, optical and electrical connections have often had disparate, or even incompatible, connection requirements. In certain industrial and military applications, however, some attempts have been made to produce hybrid connectors—ones that integrate both electrical and optical connections within a single plug or receptacle. Unfortunately, however, most such conventional hybrid connectors have not been produced in a manner that is commercially viable for high-volume, low-cost applications.

Generally, conventional hybrid connectors have been somewhat application-specific, having a fixed channel configuration related to a single cabling topology—i.e., the positioning and ratio of optical and electrical lines within a give cable. Thus, a hybrid connector designed for use with one type of cable would not be compatible for use with a cable having a different topology. Furthermore, conventional hybrid connectors are commonly produced in a custom or semi-custom manner, where the connector design is machined or molded in its final configuration—often due, at least in part, to the high level of precision needed for reliable optical connection alignment. Thus, with such conventional approaches, connectors are typically not produced in a manner compatible with high-volume mass production.

As a result, there is a need for a system that provides hybrid optical/electrical connectors—readily adaptable to a variety of configurations—produced in a cost-efficient, easily scalable manner that is compatible with utilization in commercial and consumer end-use applications.

### SUMMARY OF THE INVENTION

A versatile system, comprising various apparatus and methods, is provided for producing hybrid optical/electrical connectors. The connector architecture of the present invention provides component-based connectors that may be quickly and easily assembled or adapted to address a variety of end-use configurations. By the present invention, a wide range of commercial or consumer hybrid connector needs may be addressed with a relatively small number of universal connector components.

Specifically, the present invention provides connector insert caps oriented for presenting channel termini in either a pin (male) or socket (female) topology. Each insert cap is provided with a desired or specified number of universal channel apertures. The present invention further provides several channel inserts, each of which may be deployed in any of the universal channel apertures. Each such channel insert is formed to adapt a channel aperture for occupation by a fiber optic or an electrical terminus; or for closure or sealing by a stopper. Once the composition or topology of a cable, for which a connector is desired, has been determined, appropriate channel inserts are disposed within the channel apertures in a manner corresponding to the cable topology.

Other features and advantages of the present invention will be apparent to those of ordinary skill in the art upon reference to the following detailed description taken in conjunction with the accompanying drawings.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates one embodiment of a connector assembly in accordance with the present invention;

FIGS. 2a-2c illustrate various embodiments of systems utilizing connectors in accordance with the present invention;

FIGS. 3a-3b illustrate various embodiments of insert caps in accordance with the present invention;

FIG. 4 illustrates one embodiment of an insert cap in accordance with the present invention;

FIG. 5 illustrates one embodiment of an insert cap in accordance with the present invention;

FIG. 6 illustrates another embodiment of an insert cap in accordance with the present invention;

FIGS. 7, 8a, 8b, 9a, 9b and 9c illustrate various embodiments of channel inserts in accordance with the present invention;

FIG. 10 illustrates another embodiment of a connector assembly in accordance with the present invention; and

FIGS. 11 thru 15 illustrate cut-away cross-sectional views of the channel inserts shown in FIGS. 8a, 8b, 9a, 9b and 9c, respectively.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The present invention is hereafter illustratively described in conjunction with the design, production and operation of certain hybrid optical/electrical connectors, and related assemblies and systems. Although described in relation to such constructs and schemes, the teachings and embodiments of the present invention may be beneficially implemented with a variety of connector components or technologies. The specific embodiments discussed herein are, therefore, merely demonstrative of specific ways to make and use the invention and do not limit the scope of the invention.

The present invention provides a versatile system, comprising various constructs and methods, for producing hybrid optical/electrical connectors. The connector architecture of the present invention comprises component-based connector assemblies that may be quickly and easily arranged or adapted to address a variety of end-use configurations. Utilizing the present invention, a wide range of commercial or consumer hybrid connector needs may be provided cost-effectively with a relatively small number of mass-producible universal connector components.

Specifically, the present invention provides connector insert caps that may be easily disposed within a desired cable coupling member—i.e., a connector or receptacle. The insert caps may be oriented for presenting a given channel termini—either electrical or optical—in either a pin (male) or socket (female) topology. Each insert cap is provided with a desired or specified number of universal channel apertures. In such a manner, a relatively small number of universal insert caps may be produced to cover a wide range of potential channel configurations—where each such insert cap provides a reasonable balance of form factor versus the total number of channel apertures it can support.

The present invention further provides several standard channel inserts, each of which may be deployed in any of the universal channel apertures. Each such channel insert is produced with a form factor and material composition that adapt a given channel aperture in a desired manner. A channel insert may serve simply as a stopper, to close or seal an unused or unoccupied channel aperture. A channel insert may also adapt a channel aperture for occupation by a terminus from a fiber optic or an electrical cable or wire. As such, several varieties of channel inserts—having unique material compositions or physical features—may be provided. Once provided with a target arrangement for the channel apertures—corresponding to the topological arrangement of the constituent cables or wires—the channel apertures of the insert cap are populated with channel inserts corresponding to that target arrangement. Any changes in a target arrangement or topology do not necessitate extensive re-tooling or re-molding. Such changes may be addressed rapidly and cost-efficiently by removing or replacing channel inserts, or removing and replacing insert caps and inserting the desired channel inserts, as needed.

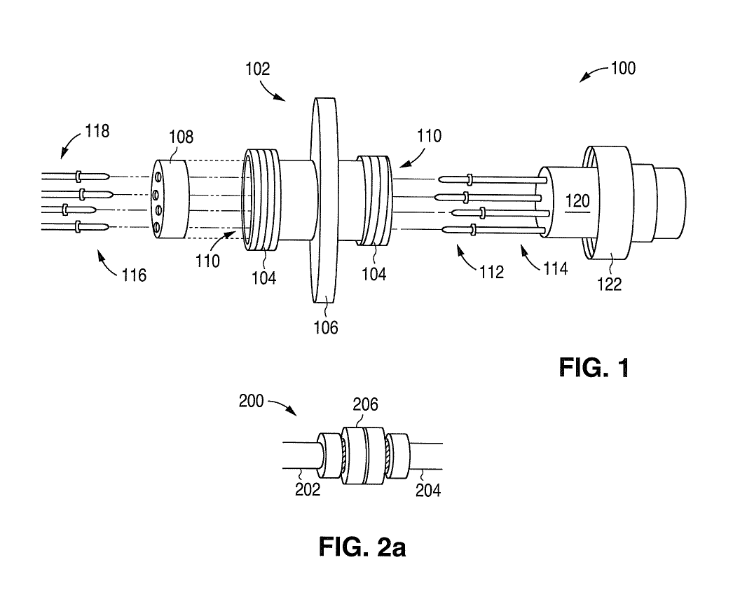

Certain aspects and embodiments of the system of the present invention are described in greater detail beginning with reference to FIG. 1, which depicts an illustrative embodiment of a simplified connector assembly 100 in accordance with the present invention. Assembly 100 comprises a connector housing 102, which may be provided in a number of configurations adapted to specific end-use applications. For example, housing 102 may comprise some engagement feature 104—such as either a “male” or “female” screw or snap-lock feature—disposed on either or both ends of the housing. Alternatively, or in addition to feature(s) 104, housing 102 may comprise some mounting feature 106—such as a flange or bracket—disposed or formed somewhere along the housing.

In certain embodiments, connector 100 may be provided as a cable-to-cable connector or a cable-terminating connector. In such embodiments, engagement features 104 may be utilized to provide necessary intercoupling. In embodiments where connector 100 is provided in a receptacle or socket configuration, one or more engagement features 106, such as a flange, may be utilized to provide for mounting of connector 100 in—for example—a wall socket. Housing 102 may be provided with a number of alternative engagement features adapted to specific end-use applications in accordance with the present invention.

Connector 100 further comprises an insert cap 108. The formation, configuration and assembly of insert cap 108 are described in greater detail hereinafter. Insert cap 108 is disposed—depending upon the application, and type of connector 100 desired—within a recess or channel 110 of housing 102, in either a permanent, fixed, or adjustable manner. In some embodiments, for example, cap 108 may be formed as an integral part of an injected molded plastic housing 102. In other embodiments, cap 108 may be epoxied or otherwise permanently secured within housing 102. In still other embodiments, cap 108 may be adjustably secured within housing 102 by, for example, screws attaching cap 108 to some internal flange or bracket within channel 110. Other similar arrangements and various combinations thereof are further comprehended by the present invention.

Cap 108 is formed or assembled to receive and secure various termini 112 from cable elements 114, for eventual interconnection to corresponding termini 116 from cable elements 118. The cable elements 118 may comprise a variety of electrical wires and/or fiber optic lines. Depending upon the particular application, cable elements 114 may be introduced into housing 102 individually, or bundled together in one or more combined cables.

As depicted in FIG. 1, elements 114 are introduced into housing 102 from a single combined cable 120. Cable 120 may comprise its own engagement feature 122 (e.g., a screw assembly), adapted to engage with one of the features 104 or 106 along housing 102, to secure and hold cable 120 and elements 114 in a fixed relationship to cap 108. In other embodiments, one of the features 104 on housing 102 may be formed or adapted to hold and secure cable 120 in fixed relationship to cap 108. For example, a feature 104 at the end of housing 102 may comprise some form of clamp or tine assembly that partially penetrates an outer insulation or covering of cable 120.

Although not depicted in FIG. 1, connector 100 may further comprise one or more intermediary elements, such as hermetic seals or insulating gaskets, which either adjoin or surround elements 114 as they are housed within connector 100. Such intermediary elements may be substantially different from insert cap 108 in structure and composition or, depending upon the embodiment, may be similar thereto. For example, a flexible seal or gasket—similar in configuration to, but different in composition from, a cap 108—may be provided within connector 100 in conjunction with cap 108 to provide, for example, shock resistance or environmental insulation. In other embodiments, a plurality of caps 108, having either similar or different material compositions, may be provided for such purposes. Other intermediary elements in accordance with the present invention are also presented and described in relation to later drawing figures, hereinafter.

Once a cap 108 is secured within housing 102, and termini 112 have been successfully and securely engaged with cap 108, connector 100 comprises a complete connector assembly—one that is now suitable for facilitating a secure eventual intercoupling of termini 116 to corresponding termini 112. Depending upon the application, connector 100 may be connected to some other connector or receptacle that houses termini 116. In other embodiments—where connector 100 serves as a receptacle connection for cable 120, for example—termini 116 and cable elements 118 may comprise some incumbent transmission elements (e.g., emanating from within a wall) that are introduced into housing 102 and cap 108 directly or individually, without having their own separate connector. Other similar configurations, and various combinations thereof, are further comprehended by the present invention.

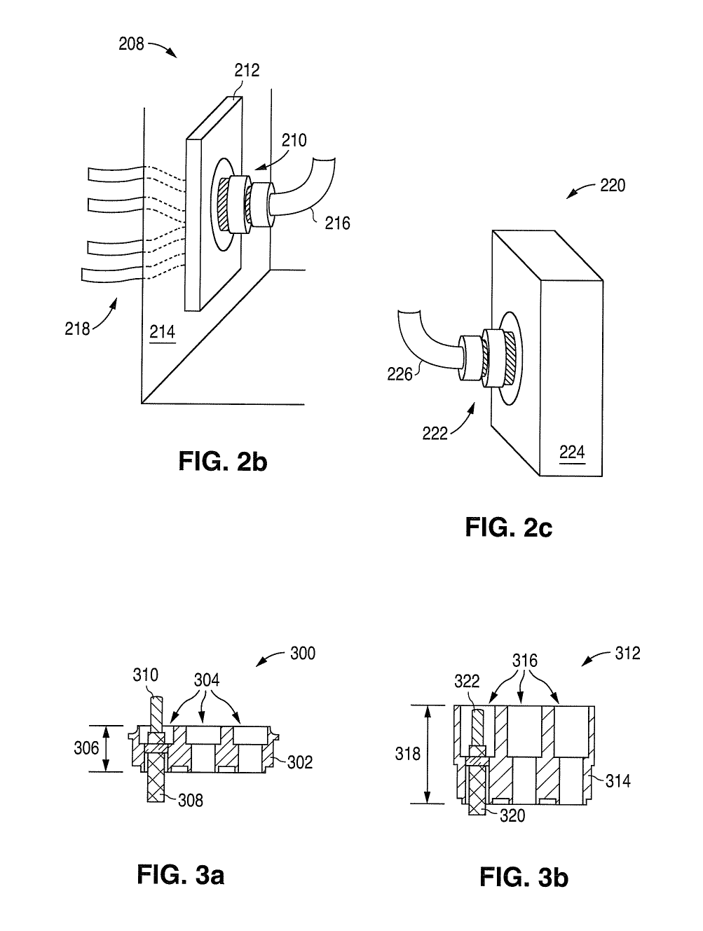

Referring now to FIGS. 2a-2c, several illustrative embodiments of end-equipment applications incorporating the connector architecture of the present invention are depicted. In FIG. 2a, for example, a cable assembly 200 comprises cable segments 202 and 204. Assembly 200 further comprises a connector 206 in accordance with the present invention, similar in structure or configuration to connector 100 of FIG. 1. Assembly 200 is representative of a wide variety of cable-to-cable intercouplings, all of which may benefit from the present invention.

In similar fashion, the connector architecture of the present invention may be provided in an outlet topology, as illustratively depicted in reference now to outlet assembly 208 of FIG. 2b. Assembly 208 comprises a connector 210 in accordance with the present invention, similar in structure or configuration to connector 100 of FIG. 1. Connector 210 may be mounted to a socket plate or panel 212 which is mounted to a wall 214 or, alternatively, may be directly mounted to wall 214. Connector 210 provides secure coupling of elements of cable 216 to corresponding cabling elements 218 (e.g., electrical wires, fiber optic lines) that are accessible from within wall 214. This embodiment is representative of a wide variety of outlet-type applications in home or office settings. For example, cable 216 may connect an associated personal computer with power, communications, or multimedia resources available via elements 218.

Referring now to FIG. 2c, the connector architecture of the present invention may also be provided in a socket topology, as illustratively depicted in reference now to socket assembly 220 of FIG. 2c. Assembly 220 comprises a connector 222 in accordance with the present invention, similar in structure or configuration to connector 100 of FIG. 1. Connector 222 may be mounted to some electronic component, device or system 224 as a socket—providing secure coupling of elements of cable 226 to signal processing or transmission sub-systems within component 224. This embodiment is representative of a wide variety of socket-type applications, in which the connector architecture of the present invention provides secure connection between various electronics systems. For example, component 224 may be a personal computer or a server, a communications router or antenna system, or some electro-mechanical system or other electronic device performing a prescribed function.

Certain aspects of the present invention are addressed to the need for “genderability” of connectors—i.e., the ability to provide a connection in either a male (i.e., pin) or female (i.e., socket) topology. The need for genderability generally arises from the conventional standard of providing “intrinsically safe” electrical connections. “Intrinsically safe” electrical conventions usually dictate that passive, uncharged connection elements may be provided in “pin” or “male” form, while live charged connection elements are provided within “socket” or “female” form—so as to prevent inadvertent contact with a live connector.

The present invention recognizes that any universal or configurable connector must therefore provide the ability to present any given termini in either a pin or socket orientation. The present invention further recognizes that—although such considerations have been addressed in some strictly electrical connector systems—genderability has typically not previously been of concern in fiber-optic connectors. Thus, in order to successfully and efficiently provide a configurable connector system, genderability must be provided for both electrical and optical connections.

The present invention provides insert caps oriented toward either a pin/male or a socket/female configuration. This is illustrated now in reference to FIGS. 3a and 3b. FIG. 3a depicts, in cross-sectional view, an illustrative embodiment of a pin/male oriented insert cap 300 according to the present invention. Cap 300 comprises a solid body portion 302, through which a plurality of channel apertures 304 are formed. The relative depth or thickness 306 of body 302 is selected or designed such that when a line or cable terminus 308 is properly disposed within an aperture 304, as secured by a channel insert (not shown), a contact portion 310 of terminus 308 extends beyond the top surface of body 302, by an amount sufficient to facilitate connection of terminus 308 with some socketed contact (not shown).

FIG. 3b depicts, in cross-sectional view, an illustrative embodiment of a socket/female oriented insert cap 312 according to the present invention. Cap 312 comprises a solid body portion 314, through which a plurality of channel apertures 316 are formed. The relative depth or thickness 318 of body 314 is selected or designed such that when a line or cable terminus 320 is properly disposed within an aperture 316, as secured by a channel insert (not shown), a contact portion 322 of terminus 320 remains recessed within an upper portion of aperture 316, by an amount sufficient to facilitate connection of terminus 320 with some pin contact (not shown).

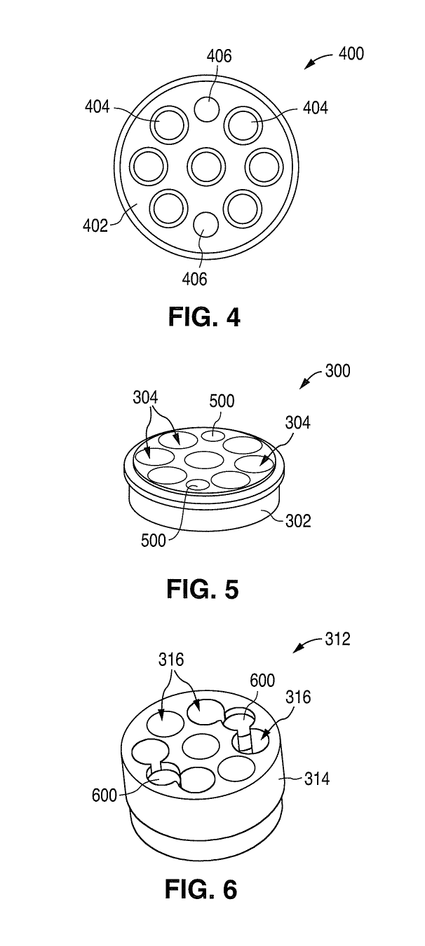

As previously mentioned, each variety of insert cap may be provided with a desired or specified number of universal channel apertures. This is illustrated now in reference to FIG. 4, which depicts a top-side view of an insert cap 400 according to the present invention. For the purposes of FIG. 4, the male/female orientation of cap 400 is not considered, since the number and configuration of channel apertures for both may be determined in the same way. Cap 400 comprises a solid body portion 402, through which a plurality of channel apertures 404 are formed. One or more attachment or alignment apertures 406 may also be formed through body 402, to facilitate the secure or aligned attachment of insert cap 400 to some other connector component (e.g., a connector housing).

The number of channel apertures 404 may be provided in various standard amounts. In the embodiment depicted in FIG. 4, seven channel apertures are provided. Caps having three, seven, nine, fifteen, or any desired number of channel apertures may be provided. Similarly, the channel apertures 404 may be provided in a balanced, symmetric configuration, or in some alternative asymmetric configuration (to perhaps provide a keyed arrangement). The number and relative configuration of channel apertures may be provided in a manner that balances form factor and functionality concerns vis-à-vis minimizing the profuseness of insert cap variations.

For purposes of illustration and explanation, the insert caps 300 and 312 of FIGS. 3a and 3b, respectively, are now depicted in quasi three-dimensional views in FIGS. 5 and 6, respectively. As shown in FIG. 5, cap 300 comprises the plurality of channel apertures 304 formed in body 302. Cap 300 also comprises a plurality of attachment/alignment apertures 500 formed through body 302. Screws, pins, posts or other fasteners or aligners may be disposed or deployed within apertures 500 to connect cap 300 to, or align it with, some other component.

As shown in FIG. 6, cap 312 comprises the plurality of channel apertures 316 formed in body 314. Cap 312 also comprises a plurality of attachment/alignment apertures 600 formed through body 314. Again, screws, pins, posts or other fasteners or aligners may be disposed or deployed within apertures 600 to connect cap 312 to, or align it with, some other component.

The universal channel apertures are generally formed of a diameter or dimension sufficient to house any electrical wire or fiber-optic line that may be used in conjunction with a connector. The dimension of the universal channel apertures may also be provided with a diameter or dimension slightly larger than the largest of any electrical wire or fiber-optic line that may be used in conjunction with the connector—sufficient to house not only the wire or line, but also an associated channel insert securing the wire or line within the channel.

Thus, in conjunction with the universal channel apertures, the present invention further provides several basic channel inserts. The channel inserts of the present invention may be disposed or secured within the channel apertures in a variety of ways, depending upon—for example—available materials or specific design requirements. In certain embodiments, for example, a channel insert may be removably secured within a channel aperture by friction fit. In other embodiments, both the channel aperture and the channel insert may be provided with engagement features (e.g., screw threads) to securely affix the insert within the aperture. In still other embodiments, the insert may be permanently affixed within the aperture by means of adhesive (e.g., epoxy) or some other bonding or securing process. Other similar variations, and various combinations thereof, are further comprehended by the present invention.

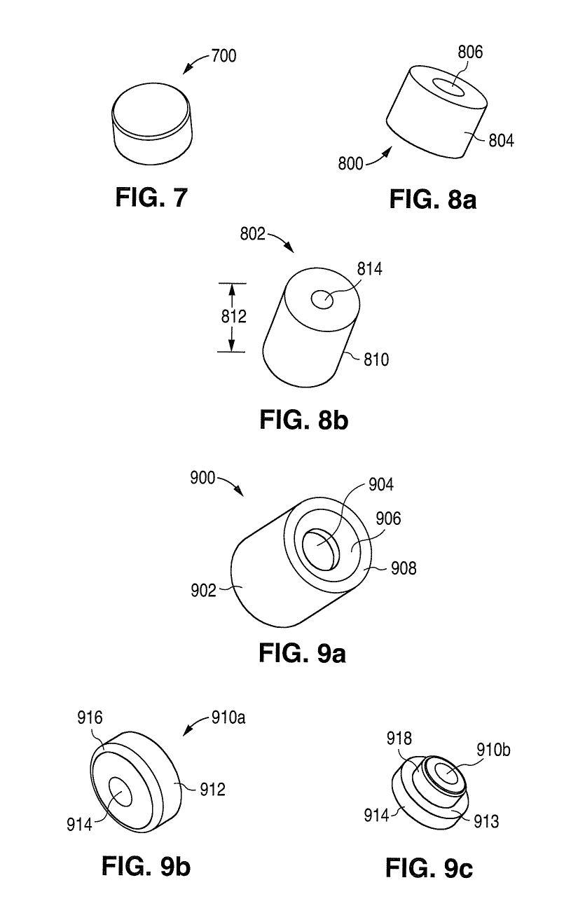

For a hybrid electrical/fiber-optic connector, three basic types of channel inserts are provided—a dummy or plug insert; a fiber-optic insert; and an electrical insert. Referring now to FIG. 7, an illustrative embodiment of a plug insert 700 is depicted. Plug 700 may be produced of any suitable material, and is formed of a dimension sufficient to close a channel aperture within which it is disposed. Plug 700 may be disposed within unutilized channel apertures in an insert cap.

Referring now to FIGS. 8a and 8b, two embodiments of a fiber-optic channel insert are provided. FIG. 8a depicts a pin/male configuration fiber-optic insert 800, while FIG. 8b depicts a socket/female configuration fiber-optic insert 802. As previously mentioned, both pin/male and socket/female varieties of the fiber-optic insert are provided to coordinate, respectively, with the pin/male and socket/female varieties of insert caps previously presented. Insert 800 comprises an insert body 804 having a central aperture 806 formed therethrough. Aperture 806 is formed of a sufficient dimension to securely hold or house a desired fiber-optic wire, a terminus associated with a fiber-optic wire, or some portion of a gimbaling apparatus associated with a fiber-optic terminus. In some embodiments, aperture 806 may be formed having various end bevels or internal chamfers, provided to facilitate the positioning or securing of a terminus or gimbaling apparatus. In certain alternative embodiments, aperture 806 may be formed having some portion of a gimbaling apparatus integrated along its inner span or around its opening. In most embodiments, however, insert 800 is formed or produced having a depth or thickness 808 sufficient only to securely accommodate a fiber-optic terminus in a pin/male orientation.

In contrast, insert 802 comprises an insert body 810 that may be formed or produced having a depth or thickness 812 sufficient to accommodate certain variations within its socket/female orientation. Insert 802 comprises a central aperture 814, formed through body 810, of a sufficient dimension to securely hold or house—in a socket/female orientation—a desired fiber-optic wire, a terminus associated with a fiber-optic wire, or some portion of a gimbaling apparatus associated with a fiber-optic terminus. Aperture 814 may also be formed having various end bevels or internal chamfers, provided to facilitate the positioning or securing of a terminus or gimbaling apparatus. In certain alternative embodiments, aperture 814 may also be formed having some portion of a gimbaling apparatus integrated along its inner span or around its opening.

Referring now to FIGS. 9a thru 9c, several embodiments of an electrical channel insert are provided. FIG. 9a depicts a base electrical insert 900. Insert 900 comprises an insert body 902 having a central aperture 904 formed therethrough. In the embodiment depicted, insert 900 is provided as both a stand-alone socket/female configuration channel insert. The insert 900 may also alternatively provide a base member for a multi-stage pin/male configuration insert (having two or more components). Insert 900 further comprises an engagement feature 906 at its upper surface. Feature 906 comprises a bevel, swale, chamfer, indentation or other suitable recess from the upper surface 908 of body 902 down to the opening of aperture 904. This feature is provided in conjunction with a complementary engagement feature on a pin/male configuration insert (single or multi-stage insert, such as the insert 910 comprising portions 912 and 913, described below) to provide for an environmentally secure sealing of an electrical connection housed therein.

Referring now to FIGS. 9b and 9c, bottom and top views of a pin/male insert stage 910 are presented, respectively. In FIG. 9b, insert stage 910 comprises an insert body 912 having a central aperture 914 formed therethrough. Insert stage 910 further comprises a first engagement feature 916 around the outer perimeter of its lower surface. Feature 916 comprises a bevel, ledge, chamfer or other gradation that—when the lower surface of stage 910 is engaged with the upper surface of insert 900—brings apertures 904 and 914 into full alignment and contact, effectively forming a single central aperture. In such a manner, insert 900 and insert stage 910 may be combined or joined to form a pin/male configuration insert.

Referring now to FIG. 9c, the upper surface features of stage 910 and, consequently, a related pin/male configuration insert, are depicted. In FIG. 9c, insert stage 910 comprises an engagement feature 918 formed upon the top surface of body 913. Engagement feature 918 comprises a protrusion, protuberance or outcropping formed such that—when a pin/male configuration insert, having engagement feature 918 along its upper surface, is brought into engagement with a socket/female insert, having an engagement feature 906—engagement features 918 and 906 mate securely and provide an environmentally secure sealing of an electrical connection housed therein. Depending upon available materials or specific design requirements, aperture 914 may extend fully through feature 918. In such embodiments, the successful engagement of features 918 and 906 bring apertures 904 and 914 into full alignment and contact, effectively forming a single central aperture therethrough.

It will be understood that male/pin/male configuration insert 910 may be configured solely of the portion 912, the portion 913, or combination of portions 912 and 913 (two-piece device). In one embodiment, the entire insert 913, or alternatively only the engagement feature 918, is constructed of a compressible material such that when coupled with a complementary insert, such as insert 900, a seal is formed. In one embodiment, the compressible material is rubber, plastic material, and may be Silastic M-RTV without additives.

In other embodiments, however, feature 918 may internally terminate aperture 914 and extend therefrom some outward projection or hub 920, having a narrowed aperture 922 formed therethrough to aperture 914. Aperture 922 may be provided, for example, in order to present only an electrical contact pin from a pin/male insert cap formed from stage 910. In such embodiments, the successful engagement of features 918 and 906 extends projection 920 into aperture 904, and projects an electrical contact pin from aperture 922 into aperture 904 for connection to another electrical contact.

In alternative embodiments, a single pin/male configuration channel insert—having the above described features and functions of the combination of insert 900 and insert stage 910 (or insert 910 comprising insert 912 and 913)—may be provided as an alternative to the two-stage embodiment described.

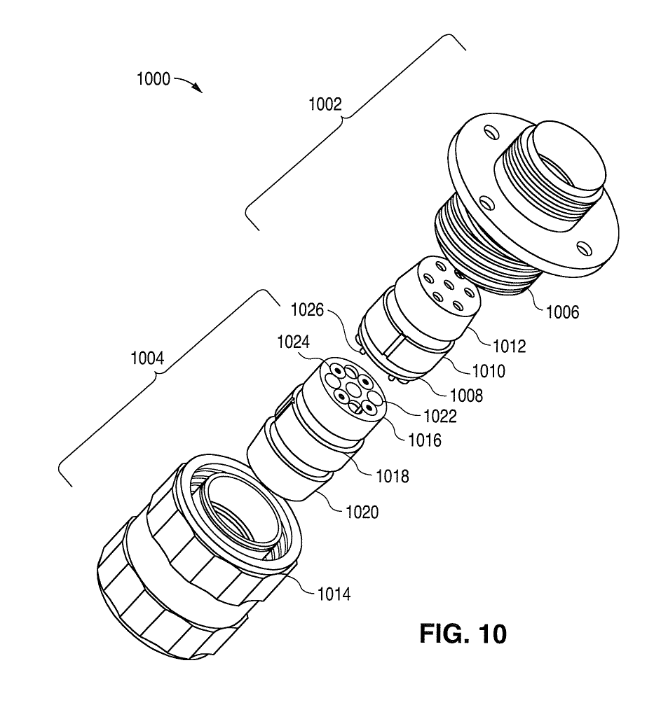

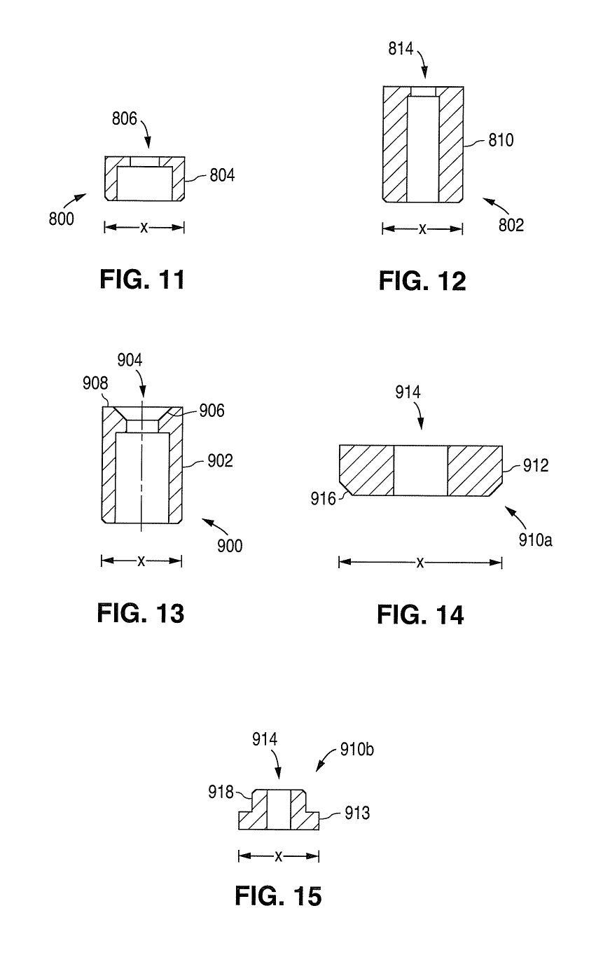

Having now described the insert caps and channel inserts of the present invention, an illustrative embodiment of an entire connection assembly 1000 according to the present invention is depicted in FIG. 10. As depicted, assembly 1000 comprises a receptacle portion 1002 and a plug portion 1004. Portion 1002 comprises a housing 1006 through which cable elements (not shown) are brought into secure engagement with a pin/male configuration insert cap 1008. Portion 1002 also comprises an insert body 1010, which is provided to retain insert cap 1008, and facilitate its fixation within housing 1006. Portion 1002 may also comprise a rear seal 1012, which is provided to facilitate stabilization and securing of the cable elements within housing 1006.

Portion 1004 comprises a housing 1014 through which cable elements (not shown) are brought into secure engagement with a socket/female configuration insert cap 1016. Portion 1004 also comprises an insert body 1018, which is provided to retain insert cap 1016, and facilitate its fixation within housing 1014. Portion 1004 may also comprise a rear seal 1020, which is provided to facilitate stabilization and securing of the cable elements within housing 1016. As depicted in FIG. 10, insert cap 1016 comprises a plurality of channel apertures 1022, having disposed therein various channel inserts 1024 in accordance with the present invention. As housings 1006 and 1014 are brought together and secured, pins 1026 extending from channel inserts (not shown) in insert cap 1008 are engaged with corresponding connections in sockets 1024—providing secure, stable connection. As will be appreciated. The insert caps 1008 and 1016 may be utilized as shown, or may be switched within the portions 1002, 1004.

The formation and assembly of the assemblies and components described herein may be provided with a wide variety of materials and processes, depending upon specific design requirements and available materials. For example, material composition of fiber-optic channel inserts may be limited to certain materials having specific thermal expansion characteristics—to limit any optic misalignment issues over an operational temperature range. Various assembly steps may be performed in a specific order to address various component sensitivities. For example, fit or alignment of channel inserts within channel apertures may be performed prior to insertion of cable termini within respective channel inserts. These and other assembly and composition variations and combinations are comprehended by the present invention.

In certain embodiments, for example, the channel inserts may comprise a 30% glass filled PEEK material. Surface finish tolerances for such inserts may be restricted to 32μ or better. Certain embodiments may utilize stainless steel screws or connectors in conjunction with attachment or alignment apertures. Similarly, certain embodiments of insert caps may comprise a 30% glass filled PEEK material. Various gaskets or seals, including the portion 913 (or portion of insert 912) may comprise a wide variety of materials, such as: silicone, Chemprene CRP 8368, or Silastic M RTV. Various assembly embodiments may utilize a number of bonding adhesives, epoxies, primers or solvents. For example, acetone may be used to clean bonding surfaces. Adhesives and epoxies such as 3145 adhesive, Eccobond 104, Lord 305 or Sylgard 577 may be used to bond seals or inserts together, or to a housing, which may include thermal heating and/or pressure. Primers such as 3-6060 and 1205 may be used to prepare various components for bonding. A number of other fabrication, preparation and assembly products, and various combinations thereof, may all be used in accordance with the present invention

It should now be easily appreciated by one of skill in the art that the system of the present disclosure provides and comprehends a wide array of variations and combinations easily adapted to a number of hybrid connector applications. The relative positions, compositions, and orientations of apertures, inserts and engagement features may be provided in any manner suitable for a particular application. Furthermore, the configurable connectors of the present invention may be utilized to provide exclusively optical or exclusively electrical connectors in a manner more economical and efficient than conventional systems. All such variations and modifications are hereby comprehended.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

The embodiments and examples set forth herein are therefore presented to best explain the present invention and its practical application, and to thereby enable those skilled in the art to make and utilize the system of the present disclosure. The description as set forth herein is therefore not intended to be exhaustive or to limit any invention to a precise form disclosed. As stated throughout, many modifications and variations are possible in light of the above teaching without departing from the spirit and scope of the following claims.

What is claimed is:

1. A configurable connector assembly, comprising:
a housing, having a channel formed therethrough
an engagement or mounting feature disposed along the housing;
an insert cap, secured to the housing within the channel, having a plurality of channel apertures formed therethrough; and
a plurality of channel inserts disposed, respectively, within the plurality of channel apertures.

2. An insert cap apparatus for a hybrid electrical/optical connector assembly, the apparatus comprising:
a body;
a plurality of channel apertures formed through the body;
an attachment aperture formed through the body; and
a plurality of channel inserts disposed, respectively, within the plurality of channel apertures.

3. An electronic system comprising:
an electronic component having electrical and optical transmission elements;
a cable having electrical and optical transmission elements body; and
a connector assembly, coupling the electrical and optical transmission elements of the cable to the electrical and optical transmission elements of the electronic components, wherein the connector assembly comprises:
an insert cap having a plurality of universal channel apertures formed through it;
an electrical channel insert, disposed within a first of the plurality of universal channel apertures, securing one of the electrical transmission elements; and
an optical channel insert, disposed within a second of the plurality of universal channel apertures, securing one of the optical transmission elements.

4. A method of producing a configurable hybrid electrical/optical connector assembly, comprising the steps of:
providing a housing, having a channel formed therethrough;
providing an insert cap, securable to the housing within the channel, having a plurality of universal channel apertures formed therethrough;
providing an electrical channel insert, disposed within a first of the plurality of channel apertures, and adapted to secure an electrical transmission element; and
providing an optical channel insert, disposed within a second of the plurality of channel apertures, and adapted to secure an optical transmission element.
